(19) United States
(12) Patent Application Publication
(10) Pub. No.: US 2015/0273387 A1
(43) Pub. Date: Oct. 1, 2015

(54) ASSIST GAS GENERATION APPARATUS FOR LASER PROCESSING MACHINE

(71) Applicant: KOMATSU INDUSTRIES CORPORATION, Kanazawa-shi, Ishikawa (JP)

(72) Inventors: Seiichi Hayashi, Komatsu-shi (JP); Koji Masauji, Kanazawa-shi (JP)

(21) Appl. No.: 14/434,530

(22) PCT Filed: Oct. 22, 2013
(86) PCT No.: PCT/JP2013/078527

§ 371 Date: Apr. 9, 2015

(30) Foreign Application Priority Data
Oct. 26, 2012 (JP) 2012-237301

(51) Int. Cl. B01D 53/22; B23K 26/14

(52) U.S. Cl. CPC B01D 53/22; B23K 26/1464; B23K 26/1405; B01D 2053/224

(57) ABSTRACT

There is provided an assist gas generation apparatus for a laser processing machine that is capable of dross-free cutting by using a nitrogen-rich gas and of reducing the cutting cost. An assist gas supply portion in a laser processing machine includes an air compressor for taking in air and compressing the air to a prescribed pressure, an oxygen separation device having an oxygen separation membrane for separating an oxygen gas from the air compressed by the air compressor and generating a nitrogen-rich gas, and a booster for compressing the nitrogen-rich gas generated by the oxygen separation device. A throttle portion is provided between the air compressor and the oxygen separation device or between the oxygen separation device and the booster.

### TECHNICAL FIELD

The present invention relates to an assist gas generation apparatus for a laser processing machine that can use a nitrogen-rich gas as an assist gas.

### BACKGROUND ART

In conventional laser processing machines, an oxygen gas was used as an assist gas during cutting of soft steel. When laser cutting is performed by using the oxygen gas as an assist gas and using the oxidation reaction heat, an oxide coating may adhere to a cut surface, which may cause a problem with welding and painting in the subsequent steps. Thus, in recent years, a nitrogen gas has been used as a method for suppressing the oxidation of the cut surface.

However, when laser cutting is performed by using the nitrogen gas as an assist gas, the oxidation reaction heat cannot be used, and thus, dross is likely to be generated. Therefore, when the nitrogen gas is used, higher gas pressure is required than when the oxygen gas is used. Higher gas pressure means that a large amount of nitrogen gas is consumed, which has been responsible for an increase in cutting cost, Several methods have been proposed as a method for reducing the cutting cost.

According to a method described in PTD 1, a separation device including a hollow fiber membrane is used to obtain a nitrogen-rich gas having a nitrogen purity of 94% to 99.5% from the air. According to a method described in PTD 2, an adsorption-type nitrogen gas generation apparatus is used.

### CITATION LIST

### Patent Document

PTD 1: Japanese Patent Laying-Open No. 7-328787

PTD 2: Japanese Patent No. 3640450

### SUMMARY OF INVENTION

### Technical Problem

However, the method described in PTD 1 has had problems of the nitrogen purity being unstable and a pressure of the nitrogen-rich gas being low. When the nitrogen purity is unstable, dross may adhere to a workpiece. On the other hand, when the pressure of the nitrogen-rich gas is low, a plate thickness in which dross-free cutting is possible is limited to extremely thin plate materials, and thus, laser processing of a desired plate thickness may be impossible. In addition, the method described in PTD 2 has had a problem in terms of reducing the cutting cost, because an adsorption device itself is expensive. The present invention has been made in light of the aforementioned problems and an object of the present invention is to provide an assist gas generation apparatus for a laser processing machine that is capable of stable dross-free cutting by using a nitrogen-rich gas and of reducing the cutting cost.

### Solution to Problem

The inventors of the present invention first researched a concentration of a nitrogen-rich gas required for dross-free cutting.

Three types of assist gasses having nitrogen concentrations of 100%, 99.5% and 99.0% were prepared, and by using the respective assist gasses, laser cutting was performed on three types of plate materials, i.e., SUS304, SECC and soft steel (SPCC), with varying thicknesses. Then, the maximum plate thickness in which dross-free cutting is possible (hereinafter referred to as “dross-free maximum cut plate thickness”) was measured.

FIG. 7(a) shows a dross-free maximum cut plate thickness in a laser processing machine having a power of 2 kW. FIG. 7(b) shows a dross-free maximum cut plate thickness in a laser processing machine having a power of 1 kW.

The results in FIG. 7(a) and FIG. 7(b) show that the dross-free maximum cut plate thickness may be smaller when the nitrogen-rich gas having a nitrogen concentration of 99.0% is used as an assist gas than when the nitrogen gas having a nitrogen concentration of 100% is used for SUS304 and soft steel. On the other hand, the results in FIG. 7(a) and FIG. 7(b) show that the equal or greater dross-free maximum cut plate thickness is obtained when the nitrogen-rich gas having a nitrogen concentration of 99.5% is used than when the nitrogen gas having a nitrogen concentration of 100% is used. Based on these results, the inventors of the present invention obtained a finding that the nitrogen-rich gas having a nitrogen concentration of approximately 99.5% may only be acquired to perform dross-free cutting. Thus, the inventors of the present invention achieved using not a nitrogen gas cylinder or an expensive adsorption-type nitrogen gas generation apparatus but a membrane-type nitrogen gas generation apparatus to generate a highly-concentrated and high-pressure nitrogen-rich gas, which has been previously difficult in the membrane-type nitrogen gas generation apparatus. The present invention provides the following aspects.

(1) An assist gas generation apparatus for a laser processing machine that emits a laser beam from a nozzle and injects an assist gas during processing, the assist gas generation apparatus comprising:

an oxygen separation device including an oxygen separation membrane for separating an oxygen gas from compressed air and generating a nitrogen-rich gas; and

a booster for compressing the nitrogen-rich gas generated by the oxygen separation device, wherein

a throttle portion is provided between the oxygen separation device and the booster.

(2) The assist gas generation apparatus for a laser processing machine according to (1), wherein a nitrogen concentration of the nitrogen-rich gas generated by the oxygen separation device is 99.5% or higher.

(3) The assist gas generation apparatus for a laser processing machine according to (1) or (2), wherein the oxygen separation device includes a plurality of oxygen separation portions each including the oxygen separation membrane, and the plurality of oxygen separation portions are connected in parallel.

(4) The assist gas generation apparatus for a laser processing machine according to (3), wherein the plurality of oxygen separation portions are arranged such that a longitudinal direction corresponds to a perpendicular direction.

### Advantageous Effects of Invention

According to the aspect described in (1) above, due to the booster, the nitrogen-rich gas having a pressure higher than an air pressure obtained at an air compressor can be supplied to the nozzle. Even when the booster is provided, a flow rate of the compressed air flowing through the oxygen separation device is stabilized due to the throttle portion, and thus, fluctuations in concentration of the nitrogen-rich gas caused by fluctuations in flow rate of the compressed air can be suppressed. This allows dross-free cutting by using the nitrogen-rich gas and reduction in cutting cost.

According to the aspect described in (2) above, preferable dross-free cutting becomes possible.

According to the aspects described in (3) and (4) above, the size of the assist gas generation apparatus can be reduced.

### BRIEF DESCRIPTION OF DRAWINGS

FIG. 1 is a schematic plan view of a laser processing machine according to one embodiment of the present invention.

FIG. 2 is a schematic side view of the laser processing machine shown in FIG. 1.

FIG. 3 is a perspective view of a processing head drive mechanism.

FIG. 4 is a perspective view of a processing head.

FIG. 5 is a back view of the laser processing machine shown in FIG. 1.

FIG. 6 is a configuration diagram of an assist gas supply portion.

FIG. 7(a) is a graph showing a dross-free maximum cut plate thickness in a laser processing machine having a power of 2 kW, and FIG. 7(b) is a graph showing a dross-free maximum cut plate thickness in a laser processing machine having a power of 1 kW.

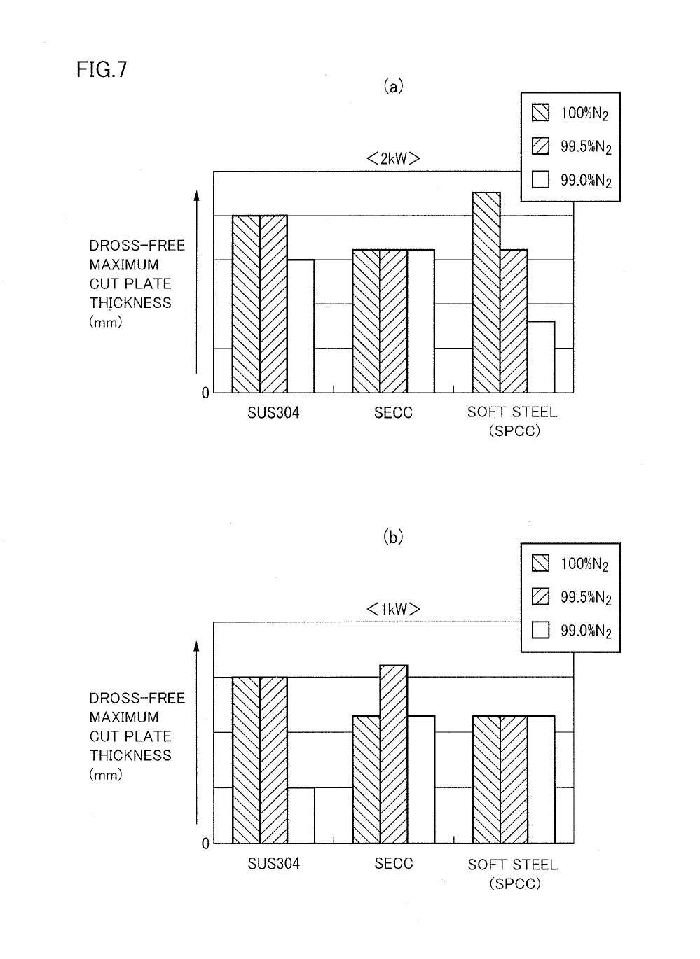

FIG. 8 is a configuration diagram of another example of the assist gas supply portion.

### DESCRIPTION OF EMBODIMENTS

As one example of a thermal cutting machine according to the present invention, one embodiment of a laser processing machine will be hereinafter described in detail with reference to the drawings.

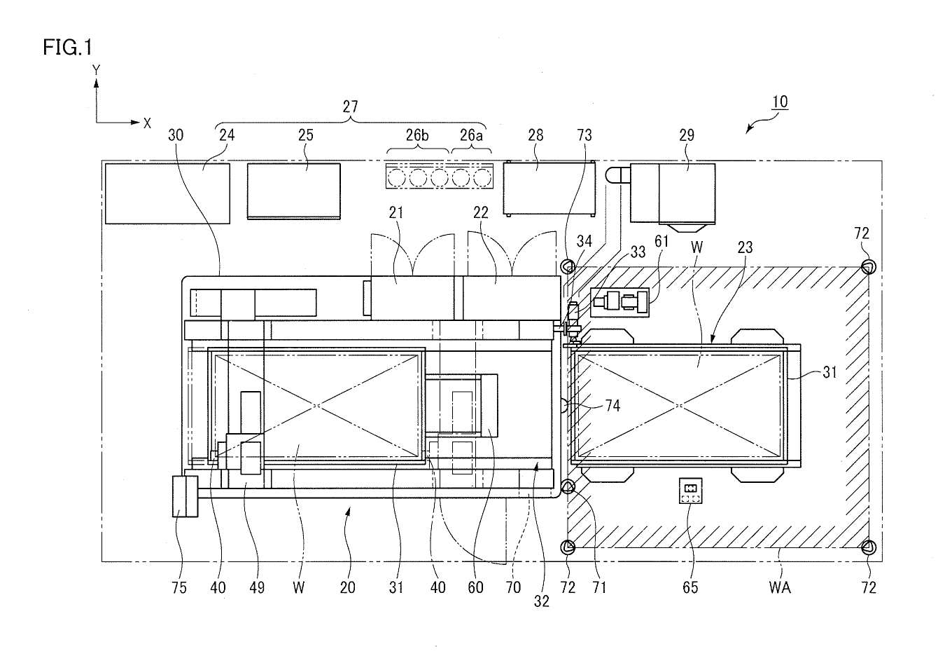

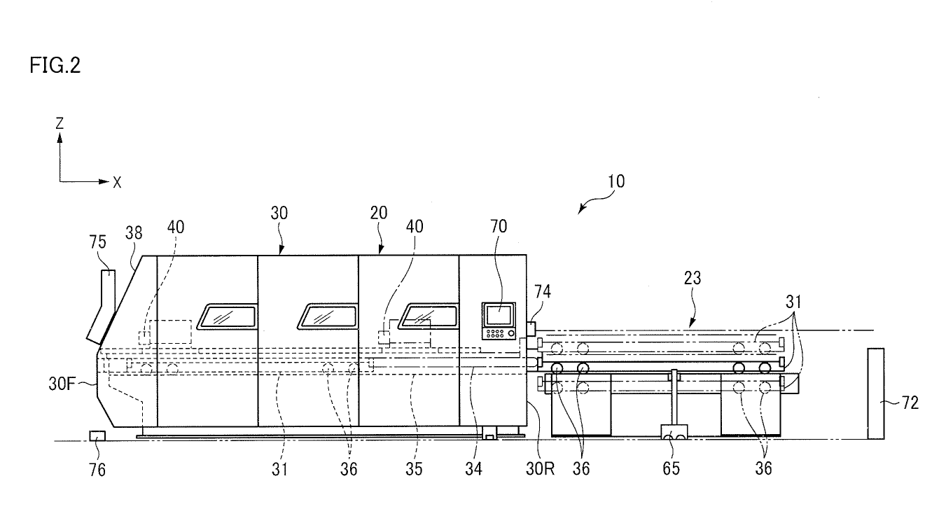

As shown in FIGS. 1 and 2, a laser processing machine 10 mainly includes a processing machine body 20, a laser oscillator 21 and a control device 22 incorporated into processing machine body 20, a pallet changer 23 disposed to be connected to processing machine body 20, an assist gas supply portion 27 including a booster 24 and an air compressor 25 used to separate a nitrogen gas in the air, or a nitrogen gas cylinder 26a, an oxygen gas cylinder 26b and the like, a chiller unit 28 for supplying cooling water that cools laser oscillator 21 and a laser processing head 40 (hereinafter referred to as “processing head”), and a dust collector 29 for removing dust and the like that occur during processing.

In the present embodiment, “frontward” refers to a direction closer to processing machine body 20 in a direction of arrangement of processing machine body 20 and pallet changer 23 (in the X direction in FIG. 1), and “rearward” refers to a direction closer to pallet changer 23 in this direction of arrangement. In addition, “leftward” and “rightward” are expressed by directions when viewing the frontward from the rearward in a direction orthogonal to the direction of arrangement (in the Y direction in FIG. 1).

Housed in a cabin 30 of processing machine body 20 are a pallet drive mechanism 32 for driving a pallet 31 in a prescribed direction, i.e., in a longitudinal direction (X direction) of cabin 30, processing head 40 for emitting laser beams for thermally cutting a workpiece W mounted on pallet 31, a processing head drive mechanism 49 for driving processing head 40, and a collection conveyor 60 for collecting scraps and the like cut during processing.

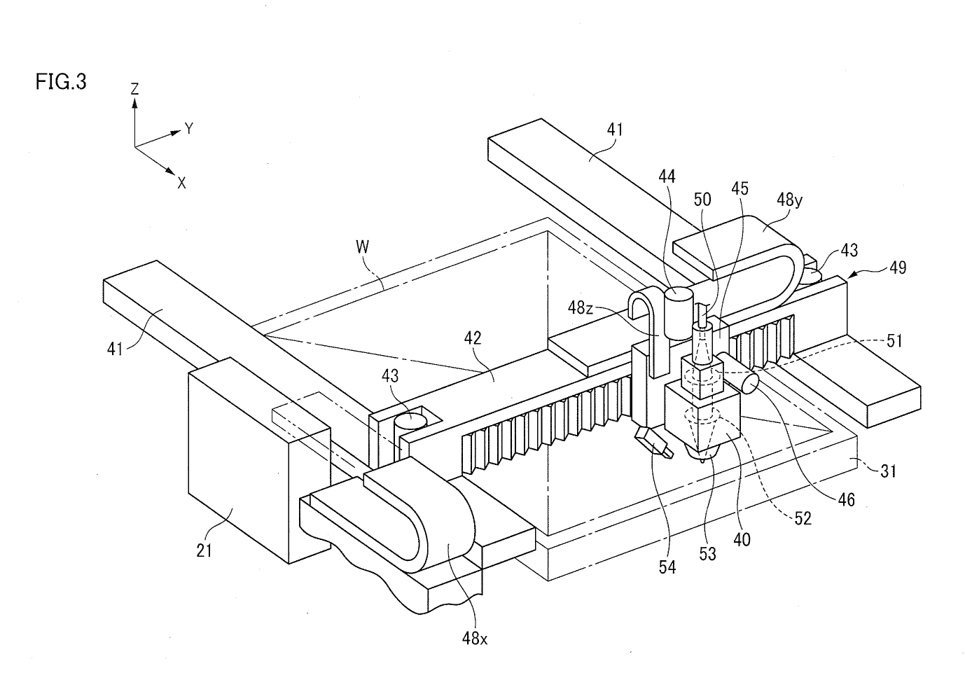

As shown in FIG. 3, processing head 40 is movable in the X direction, in a width direction (Y direction) of cabin 30, and in a vertical direction (Z direction) of cabin 30 by processing head drive mechanism 49. Specifically, a beam-like X-direction movable platform 42 is arranged to span a pair of support platforms 41 provided right and left, and this X-direction movable platform 42 is driven in the X direction by an X-axis motor 43. A Y-direction movable platform 45 that is driven by a Y-axis motor 44 and is movable in the Y direction is also disposed at X-direction movable platform 42. Y-direction movable platform 45 is driven in the Y direction by a rack and pinion mechanism for meshing a not-shown pinion fixed to a rotation shaft of Y-axis motor 44 with a not-shown rack arranged in X-direction movable platform 42. In addition, by using a rack and pinion mechanism driven by a Z-axis motor 46, processing head 40 is disposed at Y-direction movable platform 45 so as to be movable in the Z direction.

Processing head 40 shown by a solid line in FIG. 1 and a dotted line in FIG. 2 indicates a state of being located at the most frontward part in the X direction, and processing head 40 shown by an alternate long and short dash line in FIGS. 1 and 2 indicates a state of being located at the most rearward part in the X direction.

A fiber cable (only a tip thereof is shown) 50 extending from laser oscillator 21 is routed through an X-direction cableveyor (registered trademark) 48x and a Y-direction cableveyor (registered trademark) 48y, and is connected to processing head 40. Also arranged in processing head 40 are a collimator lens 51 for parallelizing the laser beams emitted from an emission end of fiber cable 50, and a condenser lens 52 for condensing the parallelized laser beams. Condenser lens 52 is provided such that a position thereof can be freely adjusted in the Z direction with respect to processing head 40. The known configuration of laser oscillator 21 for generating the laser beams can be applied, and thus, detailed description will not be repeated.

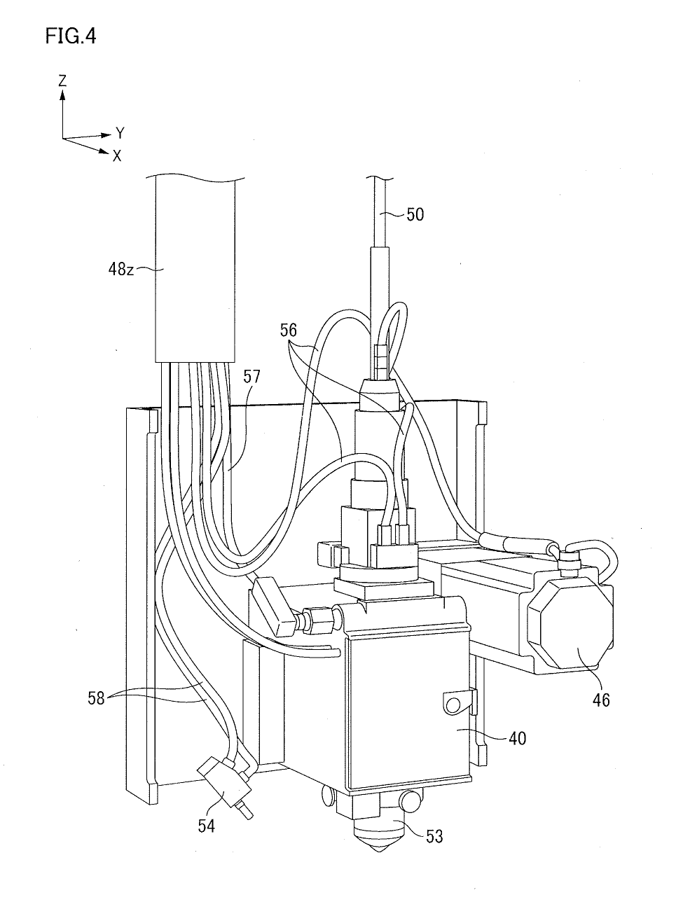

As shown in FIG. 4, a cooling pipe 56 provided from chiller unit 28 is connected around processing head 40 to cool the emission end of fiber cable 50 and the surroundings of condenser lens 52. Furthermore, provided around processing head 40 are a gas supply pipe 57 for supplying an assist gas such as a nitrogen gas or an oxygen gas from assist gas supply portion 27 into processing head 40, and another gas supply pipe 58 connected to a side nozzle 54 for spraying the assist gas such as the nitrogen gas or the oxygen gas toward the neighborhood of a laser nozzle 53 of processing head 40.

These cooling pipe 56 and gas supply pipes 57 and 58 pass through a Z-direction cableveyor (registered trademark) 48z, and then, are routed to X-direction cableveyor (registered trademark) 48x and Y-direction cableveyor (registered trademark) 48y, together with fiber cable 50, and are connected to chiller unit 28 and assist gas supply portion 27.

When laser oscillator 21 is actuated, the laser beams pass through fiber cable 50 and are parallelized by collimator lens 51. Further, the parallelized laser beams enter condenser lens 52 to be condensed, and are emitted from laser nozzle 53 to a portion of workpiece W to be processed, and processing head 40 processes workpiece W. During processing, the assist gas supplied from assist gas supply portion 27 is injected from laser nozzle 53 and side nozzle 54 toward the portion of workpiece W to be processed, such that the molten metal generated during processing is blown away.

As shown in FIGS. 1 and 2, pallet drive mechanism 32 is disposed at a position facing a right side surface of pallet 31 along the X direction, and has an endless chain 34 rotationally driven by a drive motor 33, and a rail 35 on which a plurality of rollers 36 provided on the lower surface side of pallet 31 are guided in a rolling manner and which supports pallet 31. When endless chain 34 is rotationally driven by drive motor 33, a pin (not shown) provided at endless chain 34 engages with an engagement portion (not shown) of pallet 31 and pallet 31 on rail 35 is moved in the X direction.

A gull wing 38 which is an open/close door is provided on a front surface 30F of cabin 30, and on a rear surface 30R which is the opposite side of front surface 30F, a loading/unloading port 37 formed in the shape of a horizontally long slit is provided to correspond to pallet changer 23. Thus, at the time of processing of large-lot products, pallet 31 having workpiece W placed thereon is loaded/unloaded through loading/unloading port 37, and at the time of processing of small-lot products, workpiece W is loaded/unloaded from gull wing 38. As a result, the loading/unloading operation corresponding to the lot size can be performed.

On front surface 30F, a first control panel 75 is also arranged at a lateral part of gull wing 38. On a left side surface 30L, a second control panel 70 is arranged closer to rear surface 30R. Furthermore, a foot switch 76 that can be foot-operated by the operator is arranged at front surface 30F of cabin 30 and below gull wing 38.

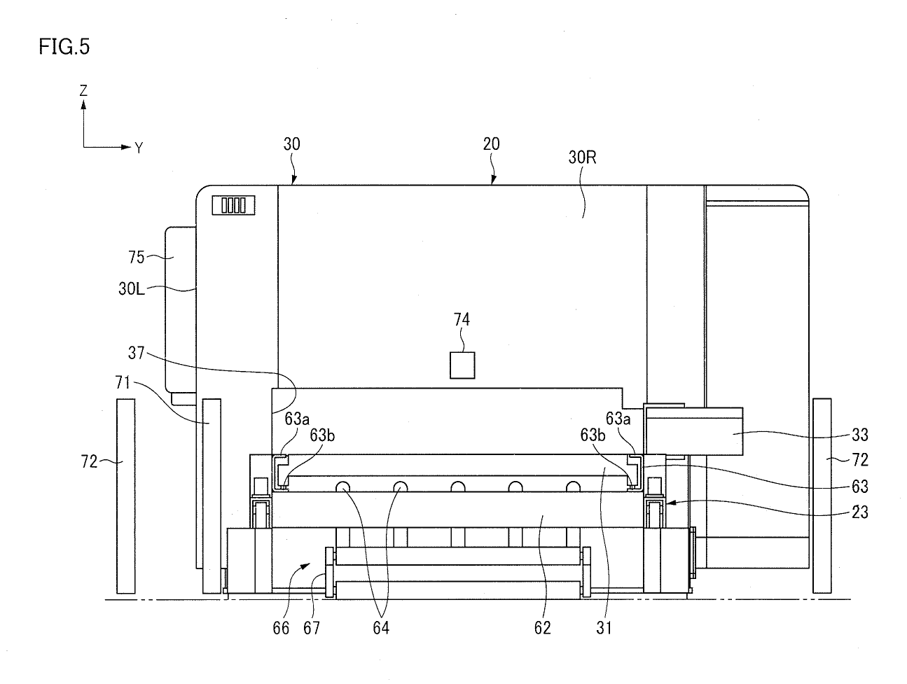

As shown in FIGS. 1, 2 and 5, pallet changer 23 is arranged to face rear surface 30R of cabin 30 having loading/unloading port 37. Pallet changer 23 has a movable frame 62 driven upwardly and downwardly by a drive mechanism 61 shown in FIG. 1, and two pallets 31 can be arranged vertically in two stages on an angular substantially C-shaped rail 63 provided at right and left lateral parts of movable frame 62.

Upper pallet 31 is placed on an upper rail surface 63a of angular substantially C-shaped rail 63, and lower pallet 31 is placed on a lower rail surface 63b of angular substantially C-shaped rail 63. A. height of pallets 31 arranged in two stages on angular substantially C-shaped rail 63 is adjustable such that when movable frame 62 is driven upwardly and downwardly by drive mechanism 61, pallets 31 on angular substantially C-shaped rail 63 can move upwardly and downwardly to come level with rail 35 disposed in cabin 30. Therefore, pallet 31 located at the same height as that of rail 35 can be loaded/unloaded between pallet changer 23 and the inside of cabin 30 through loading/unloading port 37.

As shown in FIG. 1, a sensor including a photo transmitter 71, reflectors 72 and a photo receiver 73 is arranged at each corner of a working area WA enclosing pallet changer 23, and the light emitted from photo transmitter 71 is reflected by three reflectors 72 and received by photo receiver 73, thereby monitoring entrance and exit of the operator and the like into and from working area WA. An area sensor 74 is also disposed on rear surface 30R of cabin 30 to detect whether the operator and the like are in working area WA or not. When the sensor including photo transmitter 71, reflectors 72 and photo receiver 73 or area sensor 74 is actuated, it is determined that the operator and the like are in working area WA, and the loading/unloading operation by pallet changer 23 is prohibited, and thus, the safety of the operator and the like is ensured.

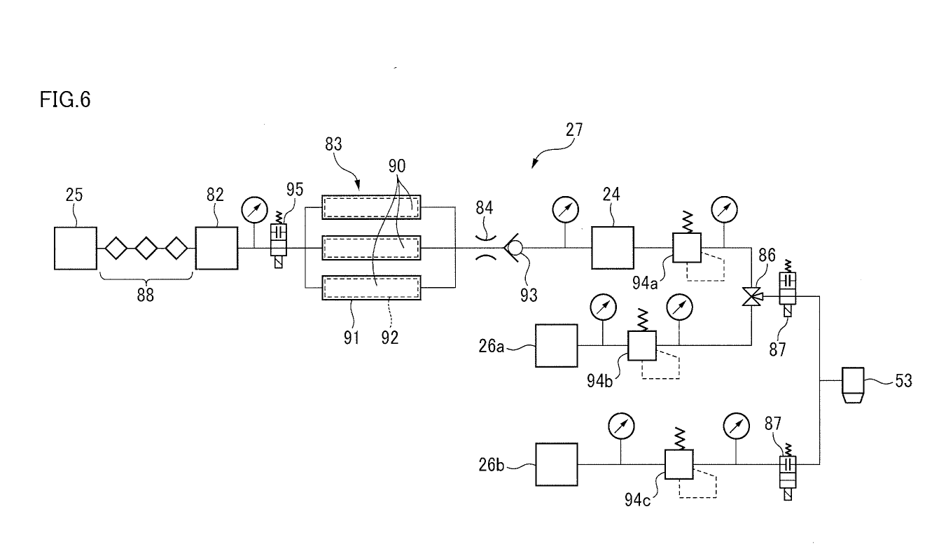

Assist gas supply portion 27 which is the feature of the present invention will be hereinafter described in detail with reference to FIG. 6.

Assist gas supply portion 27 mainly includes air compressor 25, an air drier 82, an oxygen separation device 83, a throttle portion 84, and booster 24. Assist gas supply portion 27 of the present embodiment includes nitrogen gas cylinder 26a and oxygen gas cylinder 26b, and a manual three-way valve 86 or a solenoid valve 87 allows selective use of the assist gas supplied from these cylinders. However, these are not necessarily required and may be omitted. Particularly, nitrogen gas cylinder 26a does not need to be provided except when particularly required, such as, for example, when laser processing of a workpiece having a plate thickness of 5 mm or greater is performed, because a nitrogen-rich gas having a nitrogen purity of approximately 99.5%, which is required for dross-free cutting, can be supplied from assist gas supply portion 27.

In this assist gas supply portion 27, the air compressed by air compressor 25 passes through a filter group 88 for removing dust and oil mist, and is supplied to air drier 82. In air drier 82, the water vapor contained in the compressed air is removed and the dried compressed air is supplied to the downstream side. Oxygen separation device 83 having a plurality of (three in the present embodiment) oxygen separation pipes 90 in parallel is disposed downstream of air drier 82, and booster 24 for raising the pressure of the nitrogen-rich gas discharged from oxygen separation device 83 is disposed downstream of oxygen separation device 83.

Each of oxygen separation pipes 90 that form oxygen separation device 83 has an oxygen separation membrane 92 incorporated into a housing 91, and is arranged such that a longitudinal direction corresponds to a perpendicular direction. The number of oxygen separation pipes 90 can be changed as appropriate depending on a flow rate in oxygen separation membrane 92, and at least one oxygen separation pipe 90 may only be provided. Oxygen separation membrane 92 is formed of hollow fibers made of polyimide and having a property of allowing oxygen to transmit therethrough more easily than nitrogen in the air. Therefore, while the compressed air is flowing through the inside of oxygen separation membrane 92, oxygen selectively transmits through oxygen separation membrane 92, and as a result, the nitrogen-rich gas is obtained at an exit of oxygen separation membrane 92. It is preferable that a residual oxygen concentration of the nitrogen-rich gas generated by oxygen separation device 83 is approximately 0.5%.

Booster 24 is configured such that the ON/OFF operation is controlled to maintain a prescribed pressure. Therefore, a flow rate of the nitrogen-rich gas flowing through booster 24 varies between the actuated state (ON state) and the non-actuated state (OFF state) of booster 24. When the flow rate of the nitrogen-rich gas flowing through booster 24 changes, a flow rate of the compressed air passing through oxygen separation membranes 92 of oxygen separation device 83 located upstream of booster 24 changes as well. Due to the property of oxygen separation membranes 92 of oxygen separation device 83, when the flow rate of the flowing compressed air changes, a concentration of the obtained nitrogen-rich gas changes.

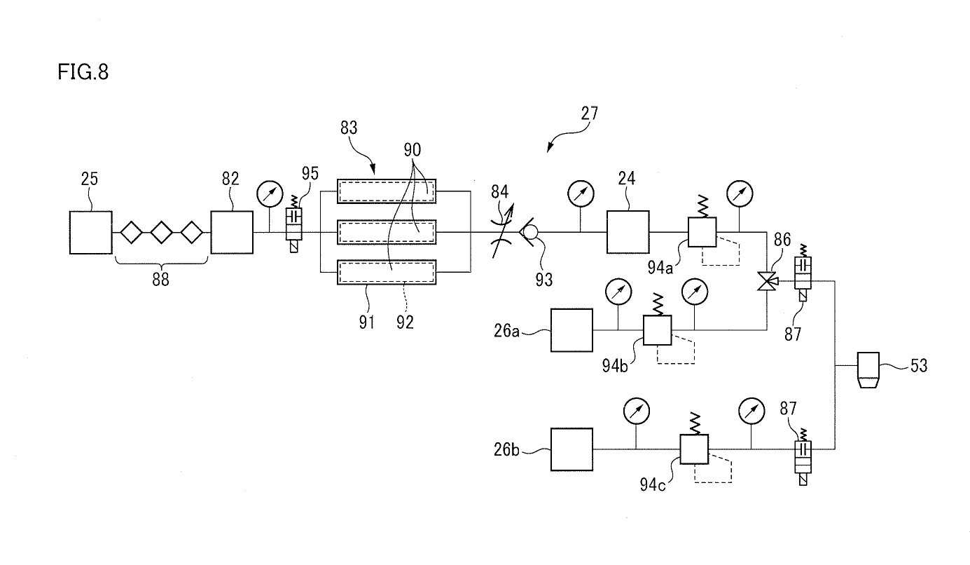

Thus, throttle portion 84 for restricting a maximum flow rate is provided between oxygen separation device 83 and booster 24 to control the flow rate of the compressed air passing through oxygen separation membranes 92 of oxygen separation device 83 to be constant. This throttle portion 84 may be provided upstream of oxygen separation device 83. A diameter of throttle portion 84 is determined depending on a nozzle diameter of laser nozzle 53, and when laser nozzle 53 having a different diameter can be used, a variable throttle such as a throttle valve in which a diameter dimension of throttle portion 84 can be adjusted as appropriate may be used as shown in FIG. 8. A reference character 93 represents a check valve for preventing backflow of the nitrogen-rich gas from the booster 24 side to the oxygen separation device 83 side. A reference character 95 represents a solenoid valve provided at an entrance of the compressed air to oxygen separation device 83, and this solenoid valve is opened when the pressure of the compressed air reaches a prescribed pressure.

A regulator valve 94a is provided on the downstream side of booster 24 to execute control to prevent the pressure on the laser nozzle 53 side from becoming higher than a prescribed pressure. Reference characters 94b and 94c also represent regulator valves arranged on the downstream side of nitrogen gas cylinder 26a and oxygen gas cylinder 26b, respectively. Regulator valve 94a is set to be, for example, 1.5 MPa to 2.5 MPa, and preferably 1.6 MPa to 2.1 MPa, and this pressure is higher than the pressure of the compressed air obtained by air compressor 25.

As described above, in assist gas supply portion 27 in laser processing machine 10 according to the present embodiment, the nitrogen-rich gas having a pressure higher than the air pressure obtained by air compressor 25 can be supplied to laser nozzle 53 due to booster 24. Even when booster 24 is provided, the flow rate of the compressed air flowing through oxygen separation device 83 is stabilized because throttle portion 84 is provided between air compressor 25 and oxygen separation device 83 or between oxygen separation device 83 and booster 24, and thus, fluctuations in concentration of the nitrogen-rich gas caused by fluctuations in flow rate of the compressed air can be suppressed. As a result, it is possible to supply the high-pressure and highly-concentrated nitrogen-rich gas in a stable manner and perform dross-free cutting while reducing the cutting cost.

In addition, the residual oxygen concentration of the nitrogen-rich gas generated by oxygen separation device 83 is approximately 0.5%, and thus, preferable dross-free cutting is possible.

In addition, the plurality of oxygen separation pipes 90 are connected in parallel, and thus, an increase in length in the longitudinal direction is suppressed and the size of assist gas supply portion 27 can be reduced. Furthermore, oxygen separation pipes 90 are arranged such that the longitudinal direction corresponds to the perpendicular direction, and thus, the size of assist gas supply portion 27 can be further reduced.

The present invention is not limited to the aforementioned embodiment, and variation, modification or the like is possible as appropriate.

Laser processing machine 10 according to the present embodiment is applicable to any laser processing machine such as a fiber laser processing machine.

In addition, in the aforementioned embodiment, the plurality of oxygen separation pipes 90 are arranged in parallel to form oxygen separation device 83. However, when the plurality of oxygen separation pipes 90 are used, these may be arranged in series to form oxygen separation device 83.

### REFERENCE SIGNS LIST

10 laser processing machine; 24 booster; 25 air compressor; 27 assist gas supply portion (assist gas generation apparatus); 53 laser nozzle (nozzle); 83 oxygen separation device; 84 throttle portion; 90 oxygen separation pipe (oxygen separation portion); 92 oxygen separation membrane.

1. An assist gas generation apparatus for a laser processing machine that emits a laser beam from a nozzle and injects an assist gas during processing, the assist gas generation apparatus comprising:
an oxygen separation device including an oxygen separation membrane for separating an oxygen gas from compressed air and generating a nitrogen-rich gas;
a booster for compressing the nitrogen-rich gas generated by said oxygen separation device; and
a throttle portion being provided between said oxygen separation device and said booster.

2. The assist gas generation apparatus for a laser processing machine according to claim 1, wherein
a nitrogen concentration of said nitrogen-rich gas generated by said oxygen separation device is 99.5% or higher.

3. The assist gas generation apparatus for a laser processing machine according to claim 1, wherein
the assist gas is injected from said nozzle.

4. The assist gas generation apparatus for a laser processing machine according to claim 1, further comprising
a side nozzle provided at a lateral part of said nozzle, for injecting the assist gas.

5. The assist gas generation apparatus for a laser processing machine according to claim 1, wherein
said oxygen separation device includes a plurality of oxygen separation portions each including said oxygen separation membrane, and
said plurality of oxygen separation portions are connected in parallel.

6. The assist gas generation apparatus for a laser processing machine according to claim 5, wherein
said plurality of oxygen separation portions are arranged such that a longitudinal direction corresponds to a perpendicular direction.
